(19) United States
(12) Patent Application Publication
(10) Pub. No.: US 2017/0280519 A1
(43) Pub. Date: Sep. 28, 2017

(54) INERT GAS BLANKETING OF ELECTRODES IN AN ELECTRIC ARC FURNACE

(71) Applicant: Air Liquide Industrial U.S. LP, Houston, TX (US)

(72) Inventor: Terence D. LASORDA, Norristown, PA (US)

(21) Appl. No.: 15/080,996

(22) Filed: Mar. 25, 2016

(51) Int. Cl. H05B 7/18; F27D 11/08; H05B 7/06

(52) U.S. Cl. CPC H05B 7/185; H05B 7/06; F27D 11/08

(57) ABSTRACT

A method for providing a region of inert gas around the electrodes in an electric arc furnace is provided. This electric arc furnace includes consumable graphite electrodes, a melting zone, and at least one lance including an inlet and an outlet, wherein the inlet is connected to a liquid inert fluid source. The method includes introducing the consumable graphite electrodes into the melting zone, wherein the distal ends of the electrodes form arcs with a solid charge of scrap metal. The method also includes introducing the liquid inert fluid into the inlet end of the at least one lance, wherein the inert fluid exits the outlet end and is introduced into the melting zone proximate to the distal ends of the electrodes, thereby providing an inert gaseous blanket, once the liquid vaporizes, around the distal ends of the electrodes

### BACKGROUND

Graphite electrodes are typically used in electric arc furnace (EAF) applications. Typically, each of the electrodes is clamped by an electrode holder to be inserted into the furnace. An arc is generated between the tip of the electrode and the materials in the furnace to cause the materials to be molten and heated up. The tip of the electrode is sublimated by the arc gradually. At the same time, the side surface at the lower part of the electrode is oxidized and consumed in high temperature atmosphere in the furnace and its shape is changed into that of a pencil, the diameter of the bottom of the electrode being decreased to about 70% as compared with the original electrode diameter.

The above-mentioned electrode consumption can be broken down, in term of figures, into 40% by arc, 5% by fall-down of the tip by thermal shock, 50% by oxidized side surface and 5% by other causes.

As compared with the electrode consumption by an arc when melting and heating scraps which is the main purpose of using a graphite electrode, the consumption of the side surface of the electrode which can be considered a real loss. This loss leads to increased electrode unit consumption, resulting in production cost increase.

Naturally there have been attempts within the industry to try to reduce this undesirable graphite electrode loss. One possible solution was the use of a protective coating. It resulted in a reduction of graphite consumption by 12-15%. However, its process, being followed by some disadvantages, required some reconstruction and adaption as well as investments in arc furnaces. Another possible solution was to eliminate side oxidation. By 1912, such electrodes as were made from metal shafts in the upper part and graphite rods as the tip had been patented.

Water cooling of the electrode has also been proposed. The disadvantage of a water cooled combination electrode was that there was no protection against a short circuiting of an arc that occurred between scraps and metal electrodes and that such a short circuiting might produce some molten holes in a metal electrode letting water flow into a furnace vessel. Thus, this method, having risk of producing explosive accidents, proved to be unusable.

Another proposed method is to provide electrodes of about insulated by high temperature resistant ceramic material, the upper parts of which are water cooled too. The active part between a metal part and an arc is made from graphite. There is no problem of short circuiting as long as the electrical and thermal insulating ceramics withstand the corrosion due to slag and scraps. But a short time after usage, cooled slag would build up thick layers on the cooled ceramic insulating material and cause corrosion and damages. The risk that whole areas of the insulation fall down and a free metal surface can build up short circuiting is extremely high.

All these apparatuses are so complicated that they need services from outside the furnace, which leads to downtime and loss of productivity. In addition, they require relatively high investment costs.

Additionally, there are a number of matters present in the current state of the art that present opportunities for improvement. The oxygen that is blown into the melt can react with the carbon content of the consumable electrode, and thereby produce unwanted greenhouse gases such as carbon monoxide and carbon dioxide.

Oxygen from the atmosphere present in the furnace reacts with the melt to produce slag. This slag represents lost steel as well as a serious health hazard for the steelworker that must rake this slag off the top of the melt.

Nitrogen from the atmosphere can be dissolved into the molten steel alloy, and can result in dissolved nitrogen anomalies in the resultant castings. Nitrogen pick-up can be reversed by blowing down the molten alloy bath with oxygen which displaces the nitrogen in the molten alloy matrix. Or the nitrogen pickup could be minimized or eliminated by use of an inert gaseous blanket in the EAF furnace interior near the ends of the electrodes during the melt cycle.

For these and other reasons, a system that would allow an inert gas shield to form around the ends of the electrodes, would improve electrode life, improve melt cycle yield, reduce alloy adds, reduce de-oxidation adds, reduce oxygen blow down, and result in a shorter melt cycle, all of which have significant economic benefits to the steel maker. Also there is improved safety since the need to de-slag would be reduced or eliminated.

### SUMMARY

A method for providing a region of inert gas around the electrodes in an electric arc furnace is provided. This electric arc furnace includes consumable graphite electrodes, a melting zone, and at least one lance including an inlet and an outlet, wherein the inlet is connected to a liquid inert fluid source. The method includes introducing the consumable graphite electrodes into the melting zone, wherein the distal ends of the electrodes form arcs with a solid charge of scrap metal. The method also includes introducing the liquid inert fluid into the inlet end of the at least one lance, wherein the inert fluid exits the outlet end and is introduced into the melting zone proximate to the distal ends of the electrodes, thereby providing an inert gaseous blanket, once the liquid vaporizes, around the distal ends of the electrodes

### BRIEF DESCRIPTION OF THE FIGURES

FIG. 1a is a schematic representation (front view) of three electrode electric arc furnace, at the beginning of a melt cycle, in accordance with one embodiment of the present invention.

FIG. 1b is a schematic representation (top view) of the furnace roof, illustrating the orientation of the three electrodes and the lance, in accordance with one embodiment of the present invention.

FIG. 1c is a schematic representation (top view) of the furnace roof, illustrating the triangular arrangement of the three electrodes, in accordance with one embodiment of the present invention.

FIG. 1d is a schematic representation (top view) of the furnace roof, illustrating the equidistant spacing of the three electrodes from the center point, in accordance with one embodiment of the present invention.

FIG. 1e is a schematic representation (front view) of the furnace roof, illustrating the distance that the lance extends from the furnace roof, in accordance with one embodiment of the present invention.

FIG. 1f is a schematic representation (front view) of the furnace roof, illustrating the inert cryogenic liquid falling into the furnace and vaporizing, in accordance with one embodiment of the present invention.

FIG. 1g is a schematic representation (front view) of the furnace roof illustrating the injection lance, in accordance with one embodiment of the present invention.

FIG. 1h is a schematic representation (front view) of the top of the furnace illustrating the injection lance and the inert gaseous blanket forming around the electrodes, in accordance with one embodiment of the present invention.

FIG. 2 is a schematic representation (front view) of three electrode electric arc furnace, at an intermediate point in a melt cycle, in accordance with one embodiment of the present invention.

FIG. 3 is a schematic representation (front view) of three electrode electric arc furnace, at completion of a melt cycle, in accordance with one embodiment of the present invention.

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure

An electric arc furnace (EAF) is a furnace that heats charged material by means of an electric arc. An electric arc furnace used for steelmaking consists of a refractory-lined vessel, usually water-cooled in larger sizes, covered with a retractable roof, and through which one or more graphite electrodes enter the furnace. The furnace is primarily split into three sections:

the shell, which consists of the sidewalls and lower steel “bowl”;

the hearth, which consists of the refractory that lines the lower bowl;

the roof, which may be refractory-lined or water-cooled, and can be shaped as a section of a sphere, or as a frustum (conical section). The roof also supports the refractory delta in its centre, through which one or more graphite electrodes enter.

The hearth may be hemispherical in shape, or in an eccentric bottom tapping furnace (see below), the hearth has the shape of a halved egg. In modern melt shops, the furnace is often raised off the ground floor, so that ladles and slag pots can easily be maneuvered under either end of the furnace. Separate from the furnace structure is the electrode support and electrical system, and the tilting platform on which the furnace rests. Two configurations are possible: the electrode supports and the roof tilt with the furnace, or are fixed to the raised platform.

A typical alternating current furnace is powered by a three-phase electrical supply and therefore has three electrodes. Electrodes are round in section, and typically in segments with threaded couplings, so that as the electrodes wear, new segments can be added. The arc forms between the charged material and the electrode, the charge is heated both by current passing through the charge and by the radiant energy evolved by the arc. The electrodes are automatically raised and lowered by a positioning system, which may use either electric winch hoists or hydraulic cylinders. The regulating system maintains approximately constant current and power input during the melting of the charge, even though scrap may move under the electrodes as it melts. The mast arms holding the electrodes can either carry heavy busbars (which may be hollow water-cooled copper pipes carrying current to the electrode clamps) or be “hot arms”, where the whole arm carries the current, increasing efficiency. Hot arms can be made from copper-clad steel or aluminum. Since the electrodes move up and down automatically for regulation of the arc, and are raised to allow removal of the furnace roof, large water-cooled cables connect the bus tubes/arms with the transformer located adjacent to the furnace. To protect the transformer from heat, it is installed in a vault and is itself cooled via pumped oil exchanging heat with the plant's water-cooling systems, as the electrical conditions for arc-furnace steelmaking are extremely stressful on the transformer.

The furnace is built on a tilting platform so that the liquid steel can be poured into another vessel for transport. The operation of tilting the furnace to pour molten steel is called “tapping”. Originally, all steelmaking furnaces had a tapping spout closed with refractory that washed out when the furnace was tilted, but often modern furnaces have an eccentric bottom tap-hole (EBT) to reduce inclusion of nitrogen and slag in the liquid steel. These furnaces have a taphole that passes vertically through the hearth and shell, and is set off-centre in the narrow “nose” of the egg-shaped hearth. It is filled with refractory sand, such as olivine, when it is closed off. Modern plants may have two shells with a single set of electrodes that can be transferred between the two; one shell preheats scrap while the other shell is utilized for meltdown. Other DC-based furnaces have a similar arrangement, but have electrodes for each shell and one set of electronics.

AC furnaces usually exhibit a pattern of hot and cold-spots around the hearth perimeter, with the cold-spots located between the electrodes. Modern furnaces mount oxygen-fuel burners in the sidewall and use them to provide chemical energy to the cold-spots, making the heating of the steel more uniform. Additional chemical energy is provided by injecting oxygen and carbon into the furnace; historically this was done through lances in the slag door, now this is mainly done through multiple wall-mounted injection units that combine the oxygen-fuel burners and the oxygen or carbon injection systems into one unit.

A mid-sized modern steelmaking furnace would have a transformer rated about 60,000,000 volt-amperes (60 MVA), with a secondary voltage between 400 and 900 volts and a secondary current in excess of 44,000 amperes. In a modern shop such a furnace would be expected to produce a quantity of 80 metric tonnes of liquid steel in approximately 50 minutes from charging with cold scrap to tapping the furnace. In comparison, basic oxygen furnaces can have a capacity of 150-300 tonnes per batch, or “heat”, and can produce a heat in 30-40 minutes. Enormous variations exist in furnace design details and operation, depending on the end product and local conditions, as well as ongoing research to improve furnace efficiency. The largest scrap-only furnace (in terms of tapping weight and transformer rating) is a DC furnace operated by Tokyo Steel in Japan, with a tap weight of 420 metric tonnes and fed by eight 32 MVA transformers for 256 MVA total power.

To produce a ton of steel in an electric arc furnace requires approximately 400 kilowatt-hours per short ton or about 440 kWh per metric tonne; the theoretical minimum amount of energy required to melt a tonne of scrap steel is 300 kWh (melting point 1520° C./2768° F.). Therefore, a 300-tonne, 300 MVA EAF will require approximately 132 MWh of energy to melt the steel, and a “power-on time” (the time that steel is being melted with an arc) of approximately 37 minutes. Electric arc steelmaking is only economical where there is plentiful electricity, with a well-developed electrical grid. In many locations, mills operate during off-peak hours when utilities have surplus power generating capacity and the price of electricity is less.

Scrap metal is delivered to a scrap bay, located next to the melt shop. Scrap generally comes in two main grades: shred (whitegoods, cars and other objects made of similar light-gauge steel) and heavy melt (large slabs and beams), along with some direct reduced iron (DRI) or pig iron for chemical balance. Some furnaces melt almost 100% DRI.

The scrap is loaded into large buckets called baskets, with “clamshell” doors for a base. Care is taken to layer the scrap in the basket to ensure good furnace operation; heavy melt is placed on top of a light layer of protective shred, on top of which is placed more shred. These layers should be present in the furnace after charging. After loading, the basket may pass to a scrap pre-heater, which uses hot furnace off-gases to heat the scrap and recover energy, increasing plant efficiency.

The scrap basket is then taken to the melt shop, the roof is swung off the furnace, and the furnace is charged with scrap from the basket. Charging is one of the more dangerous operations for the EAF operators. A lot of potential energy is released by multiple tonnes of falling metal; any liquid metal in the furnace is often displaced upwards and outwards by the solid scrap, and the grease and dust on the scrap is ignited if the furnace is hot, resulting in a fireball erupting. In some twin-shell furnaces, the scrap is charged into the second shell while the first is being melted down, and pre-heated with off-gas from the active shell. Other operations are continuous charging—pre-heating scrap on a conveyor belt, which then discharges the scrap into the furnace proper, or charging the scrap from a shaft set above the furnace, with off-gases directed through the shaft. Other furnaces can be charged with hot (molten) metal from other operations.

After charging, the roof is swung back over the furnace and meltdown commences. The electrodes are lowered onto the scrap, an arc is struck and the electrodes are then set to bore into the layer of shred at the top of the furnace. Lower voltages are selected for this first part of the operation to protect the roof and walls from excessive heat and damage from the arcs. Once the electrodes have reached the heavy melt at the base of the furnace and the arcs are shielded by the scrap, the voltage can be increased and the electrodes raised slightly, lengthening the arcs and increasing power to the melt. This enables a molten pool to form more rapidly, reducing tap-to-tap times. Oxygen is blown into the scrap, combusting or cutting the steel, and extra chemical heat is provided by wall-mounted oxygen-fuel burners. Both processes accelerate scrap meltdown. Supersonic nozzles enable oxygen jets to penetrate foaming slag and reach the liquid bath.

An important part of steelmaking is the formation of slag, which floats on the surface of the molten steel. Slag usually consists of metal oxides, and acts as a destination for oxidized impurities, as a thermal blanket (stopping excessive heat loss) and helping to reduce erosion of the refractory lining. For a furnace with basic refractory's, which includes most carbon steel-producing furnaces, the usual slag formers are calcium oxide (CaO, in the form of burnt lime) and magnesium oxide (MgO, in the form of dolomite and magnetite). These slag formers are either charged with the scrap, or blown into the furnace during meltdown. Another major component of EAF slag is iron oxide from steel combusting with the injected oxygen. Later in the heat, carbon (in the form of coke or coal) is injected into this slag layer, reacting with the iron oxide to form metallic iron and carbon monoxide gas, which then causes the slag to foam, allowing greater thermal efficiency, and better arc stability and electrical efficiency. The slag blanket also covers the arcs, preventing damage to the furnace roof and sidewalls from radiant heat.

Once the scrap has completely melted down and a flat bath is reached, another bucket of scrap can be charged into the furnace and melted down, although EAF development is moving towards single-charge designs. After the second charge is completely melted, refining operations take place to check and correct the steel chemistry and superheat the melt above its freezing temperature in preparation for tapping. More slag formers are introduced and more oxygen is blown into the bath, burning out impurities such as silicon, sulfur, phosphorus, aluminum, manganese, and calcium, and removing their oxides to the slag. Removal of carbon takes place after these elements have burnt out first, as they have a greater affinity for oxygen. Metals that have a poorer affinity for oxygen than iron, such as nickel and copper, cannot be removed through oxidation and must be controlled through scrap chemistry alone, such as introducing the direct reduced iron and pig iron mentioned earlier. A foaming slag is maintained throughout, and often overflows the furnace to pour out of the slag door into the slag pit. Temperature sampling and chemical sampling take place via automatic lances. Oxygen and carbon can be automatically measured via special probes that dip into the steel, but for all other elements, a “chill” sample—a small, solidified sample of the steel—is analyzed on an arc-emission spectrometer.

Once the temperature and chemistry are correct, the steel is tapped out into a preheated ladle through tilting the furnace. For plain-carbon steel furnaces, as soon as slag is detected during tapping the furnace is rapidly tilted back towards the deslagging side, minimizing slag carryover into the ladle. For some special steel grades, including stainless steel, the slag is poured into the ladle as well, to be treated at the ladle furnace to recover valuable alloying elements. During tapping some alloy additions are introduced into the metal stream, and more lime is added on top of the ladle to begin building a new slag layer. Often, a few tonnes of liquid steel and slag is left in the furnace in order to form a “hot heel”, which helps preheat the next charge of scrap and accelerate its meltdown. During and after tapping, the furnace is “turned around”: the slag door is cleaned of solidified slag, repairs may take place, and electrodes are inspected for damage or lengthened through the addition of new segments; the taphole is filled with sand at the completion of tapping. For a 90-tonne, medium-power furnace, the whole process will usually take about 60-70 minutes from the tapping of one heat to the tapping of the next (the tap-to-tap time).

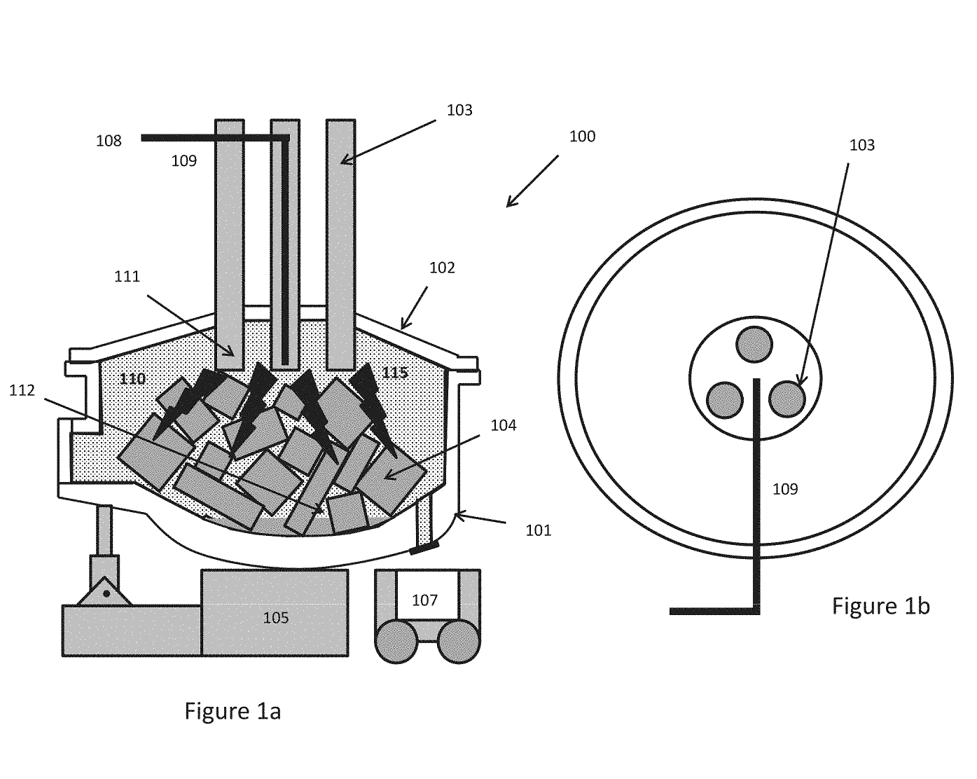

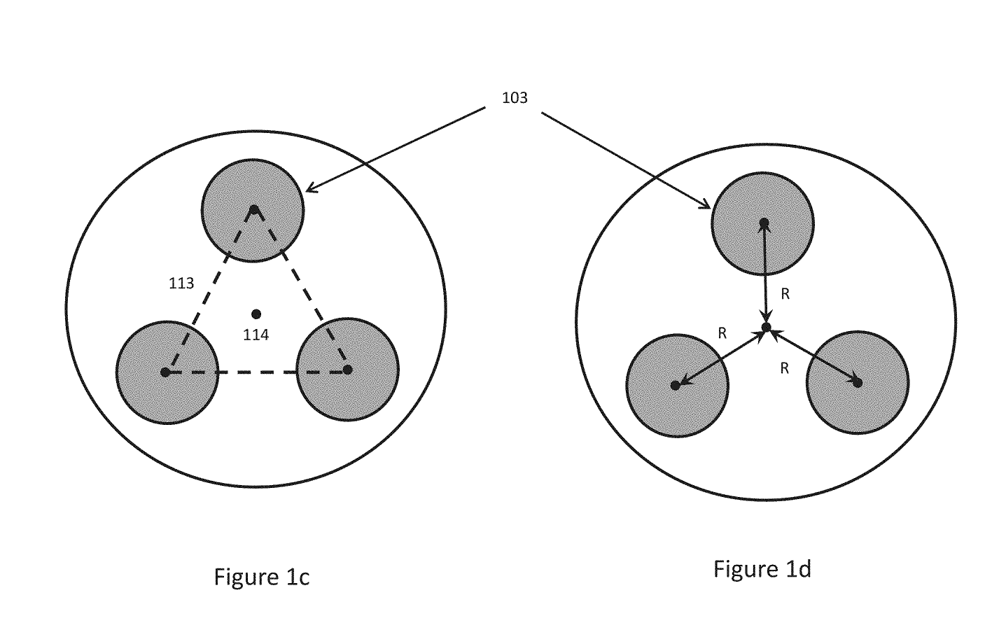

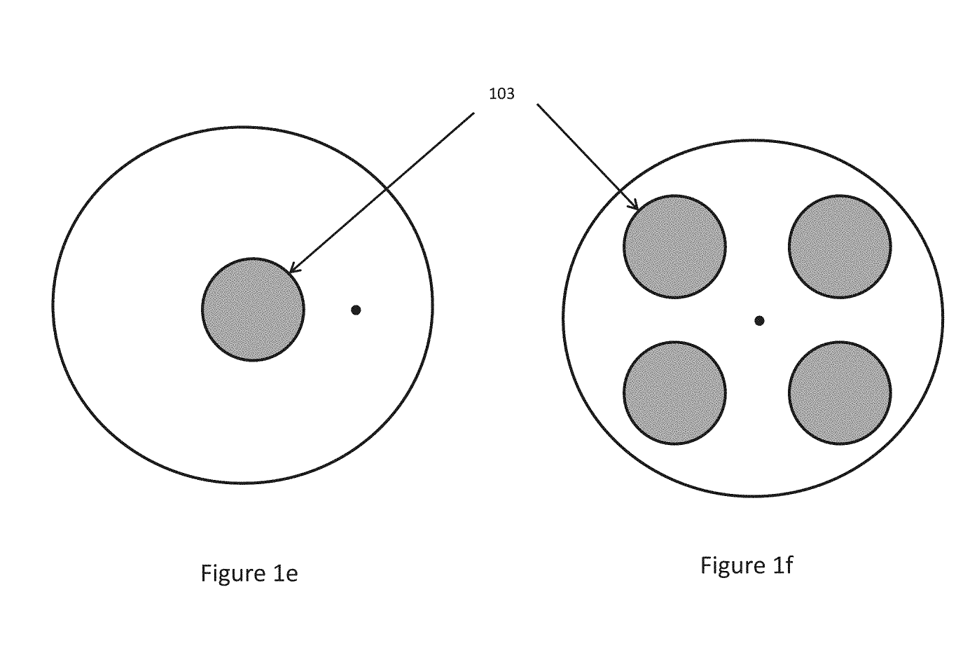

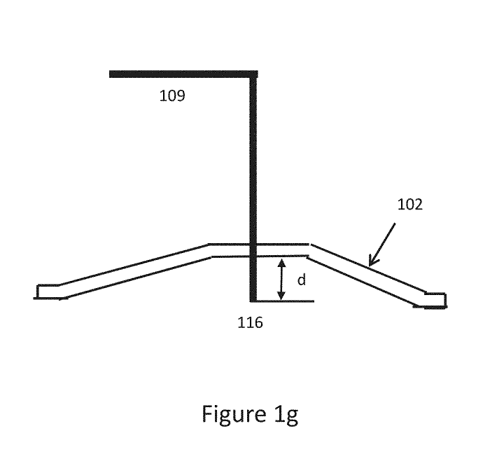

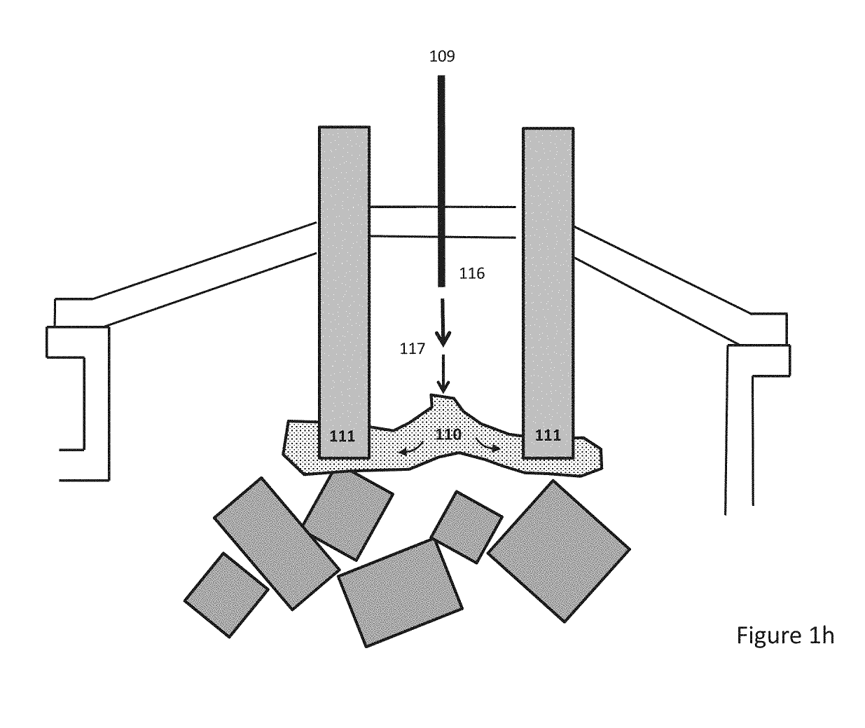

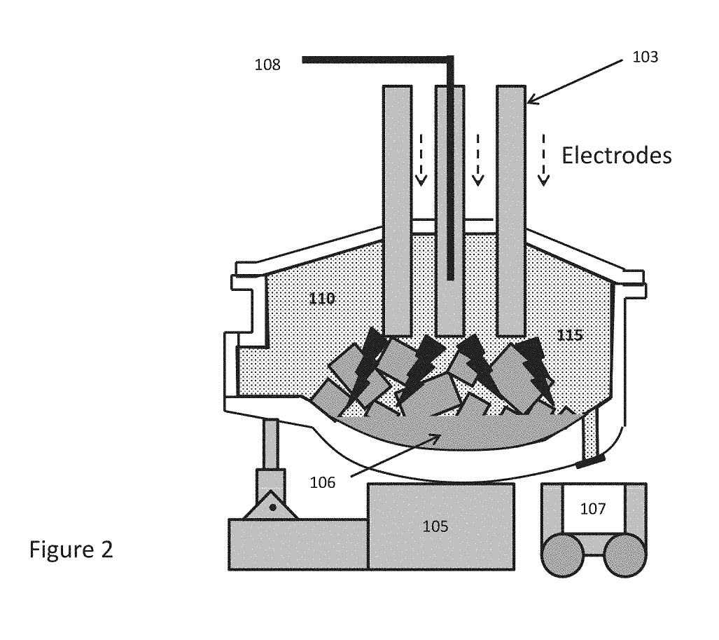

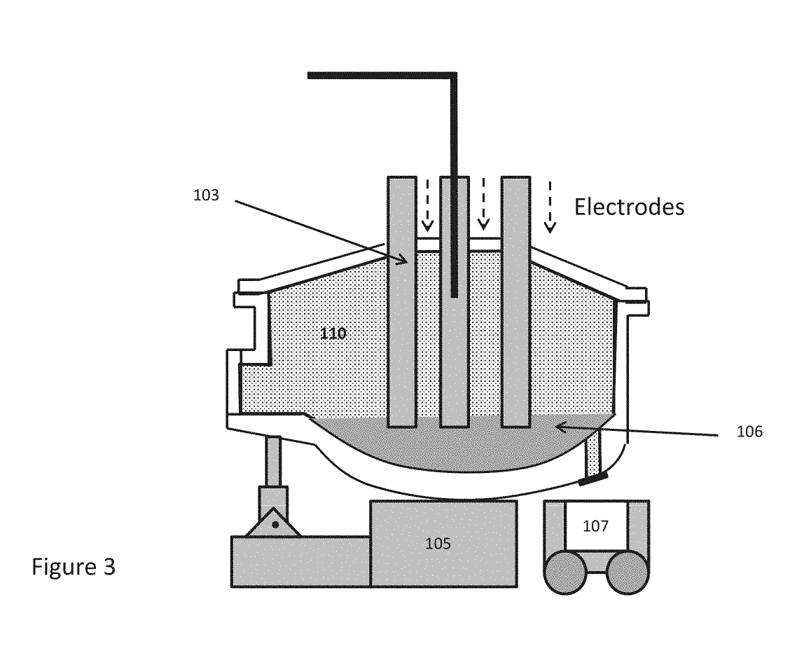

As illustrated in FIGS. 1a, 1b, 1c, 1d, 1e, 1f, 1g, 1h, 2, and 3, an electric arc furnace 100 used for steelmaking consists of a refractory-lined vessel 101, covered with a retractable roof 102, and through which one or more graphite electrodes 103 enter the furnace.

A typical alternating current furnace is powered by a three-phase electrical supply and therefore has three electrodes 103. As illustrated in FIGS. 1e and 1f, it is possible to use the present invention in electric arc furnaces with one electrode (FIG. 1e) or four electrodes (FIG. 1f). One skilled in the art would recognize that electric arc furnaces with any number of electrodes may be configured with the present invention.

Electrodes are typically round in cross-section, and typically in segments with threaded couplings, so that as the electrodes wear, new segments can be added. As illustrated in FIG. 1c, the three electrodes will typically be arranged in a generally triangular orientation. The most efficient arrangement would be to have the electrodes arranged in an equilateral triangle, with a center point 114 generally equidistant from each electrode (as illustrated in FIG. 1d).

The arc 115 forms between the charged material 104 and the electrode 103, the charge 104 is heated both by current passing through the charge and by the radiant energy evolved by the arc. The electrodes 103 are automatically raised and lowered by a positioning system.

The furnace is typically built on a tilting platform 105 so that the liquid steel 106 can be poured into another vessel 107 for transport.

To charge the electric arc furnace 100, the roof 102 is swung off the furnace, and the furnace is charged with scrap 104 from large buckets, called “baskets”. After charging, the roof 102 is swung back over the furnace and the furnace is sealed. A liquid inert fluid 108 is introduced into the electric arc furnace 100 by means of at least one lance 109. The lance 109 enters the furnace through the roof, at a location that is generally central 114 to, and equidistant R, from the three electrodes 103. The lance 109 introduces the inert fluid into the melting zone 112 in close proximity to the distal ends 111 of the electrodes 103. Due to the extreme heat in the melting zone 112, the liquid inert fluid 108 vaporizes, thereby forming an inert gaseous blanket 110 around the distal ends 111 of the electrodes 103 and to some degree around the entire melting zone 112.

The inert fluid may be a cryogenic liquid. The inert fluid may be liquid nitrogen or liquid argon. The inert fluid may be cryogenic liquid argon formulated for steel alloys.

As the meltdown commences, the electrodes 103 are lowered onto the scrap 104, an arc is struck and the electrodes 103 are then set to bore into the layer of metal at the top of the furnace. As the electrodes 103 are lowered, the lance 109 remains in a fixed position, and is not lowered along with the electrodes 103. It is important that the lance 109 be configured as to not touch, or come within arcing distance of any of the electrodes 103. As illustrated in FIG. 1g, typically, the lance 109 will protrude from the roof 102, into the furnace interior a distance of between 6 inches and 30 inches, preferably between 7 inches and 24 inches, more preferably 15 inches. As illustrated in FIG. 1h, the lance 109 releases the inert liquid cryogen 117 from the tip 116, after which the inert liquid cryogen falls by force of gravity toward the distal ends 111 of the electrodes 103. As the liquid cryogen travels toward the distal ends 111 of the electrodes 103, the intense heat of the furnace vaporizes the liquid, which forms an inert dense gaseous blanket 110 around the distal ends 111 of the electrodes 103. The liquid cryogen may be supplied to the furnace during the entire melt cycle. Once the melted metal 106 is ready, the steel is tapped out into a preheated ladle through tilting the furnace.

The electrodes 103 may be consumable graphite electrodes. The liquid inert fluid 108 is liquid nitrogen, or liquid argon. In a configuration where there are three electrodes 103 equally spaced and forming a generally triangular shape, the lance 109 may introduce the liquid inert fluid 108 into a region central to the three electrodes 103.

1. A method for providing a region of inert gas around the electrodes in an electric arc furnace including consumable graphite electrodes, a melting zone, and at least one lance including an inlet and an outlet, wherein the inlet is connected to a liquid inert fluid source, the method comprising;
introducing the consumable graphite electrodes into the melting zone, wherein the distal ends of the electrodes form arcs with a solid charge of scrap metal,
introducing the liquid inert fluid into the inlet end of the at least one lance, wherein the inert fluid exits the outlet end and is introduced into the melting zone proximate to the distal ends of the electrodes, thereby providing an inert gaseous blanket, once the liquid vaporizes, around the distal ends of the electrodes.

2. The method of claim 1, wherein the liquid inert fluid is liquid nitrogen.

3. The method of claim 1, wherein the liquid inert fluid is liquid argon.

4. The method of claim 1, wherein the liquid inert fluid is cryogenic liquid argon formulated for steel alloys.

5. The method of claim 1, wherein there are three consumable graphite electrodes.

6. The method of claim 4, wherein the three consumable graphite electrodes are arranged in a generally triangular pattern.

7. The method of claim 5, wherein the at least one lance introduces the liquid inert fluid into a region central to the three consumable graphite electrodes.
